(19) United States
(12) Patent Application Publication
(10) Pub. No.: US 2014/0113569 A1
(43) Pub. Date: Apr. 24, 2014

(54) CROSS POLARIZATION INTERFERENCE CANCELLATION DEVICE AND CROSS POLARIZATION INTERFERENCE CANCELLATION METHOD

(71) Applicant: Jungo Arai, Tokyo (JP)

(72) Inventor: Jungo Arai, Tokyo (JP)

(21) Appl. No.: 14/123,930

(22) PCT Filed: Jun. 5, 2012
(86) PCT No.: PCT/JP2012/064464

§ 371 Date: Dec. 4, 2013

(30) Foreign Application Priority Data
Jun. 7, 2011 (JP) 2011-127140

(51) Int. Cl. H04B 15/00

(52) U.S. Cl. CPC H04B 15/00
USPC 455/63.1

(57) ABSTRACT

A cross polarization interference cancellation device is applied to a radio communication device in a co-channel transmission system which carries out radio communication by use of auto-polarization waves and hetero-polarization waves with phase orthogonally crossing each other at the same frequency. The cross polarization interference cancellation device includes a first filter of eliminating unwanted components from an auto-polarization signal; a second filter of eliminating unwanted components from a hetero-polarization signal; a cross polarization interference cancellation part which is connected to the second filter so as to generate a cross-polarization interference cancellation signal which is used to eliminate a cross-polarization interference component superimposed on the auto-polarization signal; and an operator of subtracting the cross-polarization interference cancellation signal from the auto-polarization signal passing through the first filter. Herein, the frequency band of the first filter is included in the frequency band of the second filter.

### TECHNICAL FIELD

The present invention relates to a cross polarization interference cancellation device and a cross polarization interference cancellation method applicable to a wireless communication device of a co-channel transmission system carrying out radio communication sending different signals via V-polarized waves and H-polarized waves both having the same frequency.

The present application claims priority on Japanese Patent Application No. 2011-127140 filed Jun. 7, 2011, the entire content of which is incorporated herein by reference.

### BACKGROUND ART

Recently, as a multiplexing radio communication system intended for the effective use of frequency resources of radio waves, a radio communication device of a co-channel transmission system carrying out radio communication sending different signals via V-polarized waves and H-polarized waves both having the same frequency has been employed.

Due to an interference occurring between V-polarized waves and H-polarized waves both having the same frequency in the co-channel transmission system, a cross polarization interference canceller (XPIC) cancelling polarization interference needs to be installed in a receiver device of the co-channel transmission system. For example, Patent Literature Document 1 discloses a cross polarization interference cancellation method.

### CITATION LIST

### Patent Literature Document

Patent Literature Document 1: Japanese Patent Application Publication No. S61-148931

### SUMMARY OF INVENTION

### Technical Problem

The cross polarization interference cancellation method disclosed in Patent Literature Document 1 is configured based on the precondition that the same modulation rate is applied to both of horizontally-polarized waves and vertically-polarized waves.

FIG. 11 is a drawing used to explain an interleave transmission method. Some countries or regions distributed radio communication licenses to grant interleaved allocations of signal propagation frequencies via horizontal polarization and vertical polarization. Radio communication devices with low adjacent-channel interference resistance between adjacent frequency bands are allowed to deploy interleaved allocations of signal propagation frequencies via horizontally-polarized waves and vertically-polarized waves.

Transmitting horizontally-polarized and vertically-polarized waves, with maximum bandwidths in the co-channel transmission system deploying interleaved allocations via horizontally-polarized and vertically-polarized waves, is possibly led to a negative influence exerted on radio communication due to interference occurring between radio communication devices using adjacent channels.

The cross polarization interference cancellation method of Patent Literature Document 1, which aims to suppress interference in radio communication devices using adjacent channels, needs to limit frequency bandwidths of horizontally-polarized and vertically-polarized waves in the co-channel transmission system, thus achieving radio communication with unifying frequency bandwidths of horizontally-polarized and vertically-polarized waves.

Due to the limitations to frequency bandwidths, it is impossible for countries and regions distributing radio communication licenses to grant interleaved allocation via horizontally-polarized and vertically-polarized waves to achieve radio communication in the co-channel transmission system maximally using frequency bands allowed for horizontally-polarized and vertically-polarized waves.

The present invention is made in consideration of the aforementioned circumstances, and it is an object of the invention to provide a cross polarization interference cancellation device and a cross polarization interference cancellation method, each of which is able to carry out a cross polarization cancellation process in the co-channel transmission method using auto-polarization waves and hetero-polarization waves having different frequency bandwidths.

### Solution to Problem

The present invention provides a cross polarization interference cancellation device adapted to a radio communication device in a co-channel transmission system using auto-polarization waves and hetero-polarization waves with phases orthogonally crossing each other at the same frequency. The cross polarization interference cancellation device includes a first filter which is configured to eliminate components other than the predetermined frequency band from an auto-polarization signal; a second filter which is configured to eliminate components other than the predetermined frequency band from a hetero-polarization signal; a cross polarization interference cancellation part which is connected to the second filter so as to generate a cross-polarization interference cancellation signal which is used to eliminate the hetero-polarization signal serving as a cross-polarization interference component superimposed on the auto-polarization signal; and an operator which is configured to subtract the cross-polarization interference cancellation signal from the auto-polarization signal passing through the first filter, thus compensating for the auto-polarization signal. Herein, the frequency band of the first filter is included in the frequency band of the second filter.

The present invention provides a cross polarization interference cancellation method adapted to radio communication in a co-channel transmission system using auto-polarization waves and hetero-polarization waves with phases orthogonally crossing each other at the same frequency. The cross polarization interference cancellation method includes a first filtering process of eliminating components other than the predetermined frequency band from an auto-polarization signal; a second filtering process of eliminating components other than the predetermined frequency band from a hetero-polarization signal; a cross polarization interference cancellation process of generating a cross-polarization interference cancellation signal which is used to eliminate the hetero-polarization signal serving as a cross-polarization interference component superimposed on the auto-polarization signal based on the hetero-polarization signal after the second filtering process; and an operation process of subtracting the cross-polarization interference cancellation signal from the auto-polarization signal passing through the first filtering process, thus compensating for the auto-polarization signal. Herein, the frequency band of the first filtering process is included in the frequency band of the second filtering process.

### Advantageous Effects of Invention

According to the present invention, it is possible to carry out a cross polarization interference cancellation process in radio communication in the co-channel transmission method using auto-polarization waves and hetero-polarization waves having different frequency bandwidths. That is, it is possible for the present invention to carry out a cross polarization interference cancellation process even when frequency bandwidths of horizontally-polarized waves are broader than frequency bandwidths of vertically-polarized waves or when frequency bandwidths of horizontally-polarized waves are narrower than the frequency bandwidths of vertically-polarized waves.

In other words, due to interleaved allocations of signal propagation frequency bands via auto-polarization waves and hetero-polarization waves (e.g. horizontally-polarized waves and vertically-polarized waves), it is possible to realize a co-channel transmission system, intended for the effective use of frequency bands in radio communication, by way of a cross polarization interference cancellation process irrespective of deviations of frequency band signals between auto-polarization waves and hetero-polarization waves.

### BRIEF DESCRIPTION OF DRAWINGS

FIG. 1 is a block diagram showing the configuration of a cross polarization interference cancellation device installed in a receiver device according to a first embodiment of the present invention, illustrating a cross polarization interference cancellation process when frequency bandwidths of vertically-polarized waves are narrower than those of horizontally-polarized waves.

FIG. 2 is a block diagram showing the configuration of a cross polarization interference cancellation device installed in the receiver device according to the first embodiment of the present invention, illustrating a cross polarization interference cancellation process when frequency bandwidths of vertically-polarized waves are broader than those of horizontally-polarized waves

FIG. 3 is a conceptual drawing showing a co-channel transmission system used to transmit horizontally-polarized waves having frequency bands included in frequency bands of arbitrary vertically-polarized waves via interleaved allocations.

FIG. 4 is a block diagram showing the configuration of a cross polarization interference cancellation device installed in a receiver device according to a second embodiment of the present invention, illustrating a cross polarization interference cancellation process when frequency bandwidths of vertically-polarized waves are narrower than those of horizontally-polarized waves

FIG. 5 is a block diagram showing the configuration of a cross polarization interference cancellation device installed in the receiver device according to the second embodiment of the present invention, illustrating a cross polarization interference cancellation process when frequency bandwidths of vertically-polarized waves are broader than those of horizontally-polarized waves

FIG. 6 is a conceptual drawing used to explain that a small tap coefficient is set to an XPIC part when frequency bandwidths of auto-polarization receive signals are broader than frequency bandwidths of hetero-polarization receive signals.

FIG. 7 is a conceptual drawing used to explain that a large tap coefficient is set to the XPIC part when the frequency bandwidths of auto-polarization receive signals are narrower than the frequency bandwidths of hetero-polarization receive signals.

FIG. 8 is a conceptual drawing used to explain that a small tap coefficient is set to the XPIC part due to an interference gain adjuster amplifying hetero-polarization receive signals even when the frequency bandwidths of auto-polarization receive signals are narrower than the frequency bandwidths of hetero-polarization receive signals

FIG. 9 is a block diagram showing the configuration of a cross polarization interference cancellation device according to a third embodiment of the present invention.

FIG. 10 is a block diagram showing the configuration of a cross polarization interference cancellation device according to a fourth embodiment of the present invention.

FIG. 11 is a conceptual drawing used to explain a co-channel transmission system deploying interleaved allocations of signal propagation frequencies via horizontally-polarized waves and vertically-polarized waves.

### DESCRIPTION OF EMBODIMENTS

The present invention does not necessarily apply the same frequency band to auto-polarization receive signals and hetero-polarization receive signals. That is, the present invention aims to carry out a cross polarization interference cancellation process in a co-channel transmission system which is able to vary and set frequency bandwidths to auto-polarization receive signals and hetero-polarization receive signals independently.

In short, the present invention relates to a cross polarization interference cancellation device which is able to carry out a cross polarization interference cancellation process in the co-channel transmission system even when the modulation rates of auto-polarization receive signals differ from those of hetero-polarization receive signals or even when frequency bandwidths of auto-polarization receive signals differ from those of hetero-polarization receive signals, in other words, even when the frequency bandwidths of auto-polarization receive signals are partially overlapped with or mutually deviated from frequency bandwidths of hetero-polarization receive signals or even when their frequency bandwidths are mutually varied over time. Hereinafter, the present invention will be described by way of embodiments with reference to the accompanying drawings.

### First Embodiment

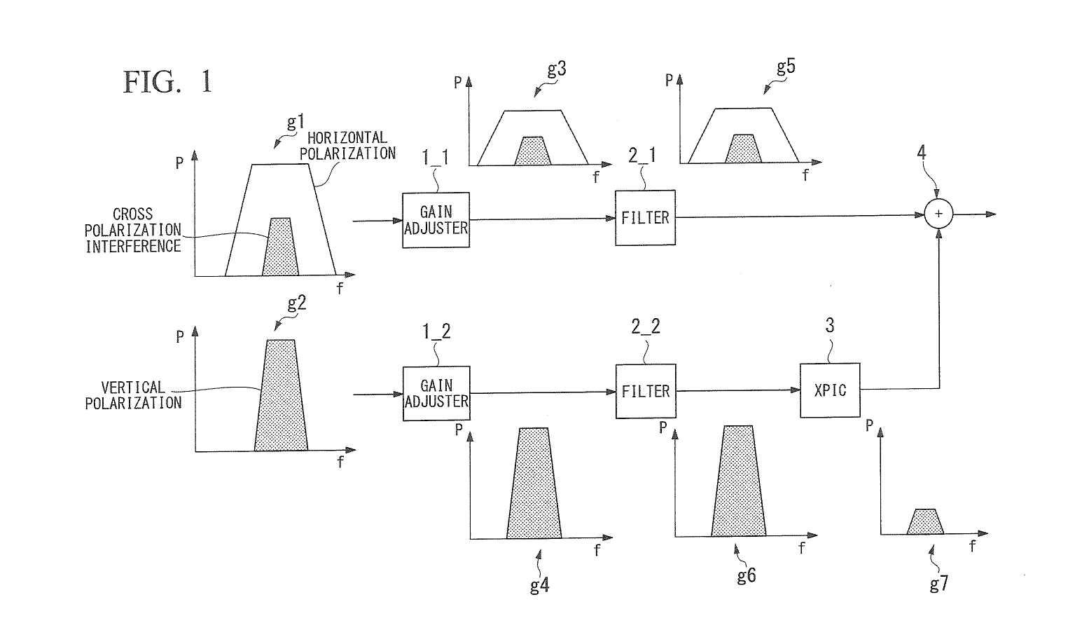

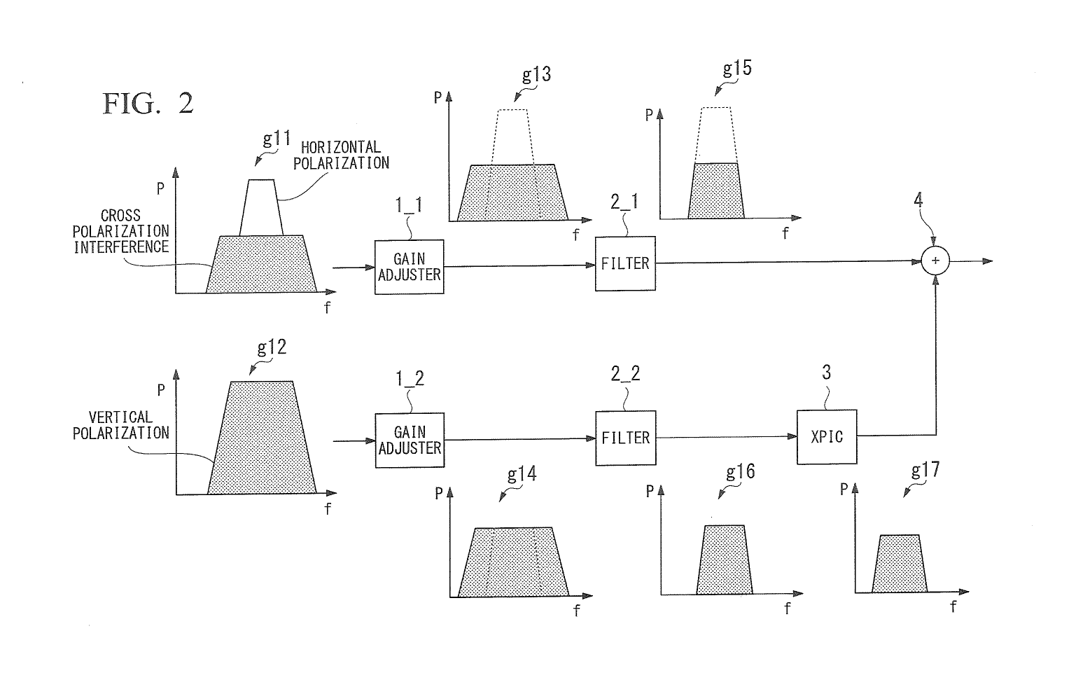

FIGS. 1 and 2 are block diagrams each showing the configuration of a cross polarization interference cancellation device installed in a receiver device according to the first embodiment of the present invention.

The receiver device of the first embodiment is configured to vary frequency bandwidths in auto-polarization receive signals and hetero-polarization receive signals, thus achieving interleaved allocations of signal propagation frequencies in horizontally-polarized waves and vertically-polarized waves. In a co-channel transmission method utilizing polarized waves in vacant frequency bands via interleaved allocations, the frequency bandwidths of an auto-polarization receive signal may differ from that of a hetero-polarization receive signal due to differences of modulation rates between horizontally-polarized waves and vertically-polarized waves. In this case, as described above, the co-channel transmission method may involve different frequency bandwidths between auto-polarization receive signals and hetero-polarization receive signals since hetero-polarization receive signals serve as interference waves against auto-polarization receive signals.

The first embodiment is configured such that horizontally-polarized waves are used as auto-polarization waves while vertically-polarized waves are used as hetero-polarization waves, but the first embodiment can be reconfigured such that vertically-polarized waves are used as auto-polarization waves while horizontally-polarized waves are used as hetero-polarization waves.

The cross polarization interference cancellation device of FIG. 1 includes gain adjusters 1_1, 1_2, filters 2_1, 2_2, an XPIC (Cross Polarization Interference Canceller) part 3, and an operator 4. The cross polarization interference cancellation device of FIG. 1 is equipped with a means of establishing clock synchronization and received signal synchronization (not shown). In the cross polarization interference cancellation device using horizontally-polarized waves as auto-polarization waves, horizontally-polarized components of received signals are used as auto-polarization received signals while vertically-polarized components of received signals are used as hetero-polarization receive signals. In the cross polarization interference cancellation device using vertically-polarized waves as auto-polarization waves, vertically-polarized components of received signals are used as auto-polarization received signals while horizontally-polarized components of receive signals are used as hetero-polarization receive signals

The gain adjuster 1_1 adjusts the level of an auto-polarization receive signal to maintain the auto-polarization receive signal at constant power. The gain adjuster 1_2 adjusts the level of a hetero-polarization receive signal to maintain the hetero-polarization receive signal at constant power.

The filter 2_1 removes signal components of frequency bands other than a desired frequency band which is determined in advance, thus allowing an auto-polarization receive signal of the desired frequency band, among auto-polarization receive signals whose power is adjusted by the gain adjuster 1_1, to solely pass therethrough.

The filter 2_2 removes signal components of frequency bands other than a desired frequency band which is determined in advance, thus allowing a hetero-polarization receive signal of the desired frequency band, among hetero-polarization receive signals whose power is adjusted by the gain adjuster 1_2, to solely pass therethrough.

The filters 2_1 and 2_2 should be each set to have a frequency bandwidth including the horizontal-polarization frequency band corresponding to auto-polarization receive signals. In the first embodiment, the filters 2_1 and 2_2 are each set to have a frequency bandwidth including the horizontal-polarization frequency band.

The filter 2_1 is followed by the XPIC (cross polarization interference cancellation) part 3 which generates a cross-polarization interference cancellation signal to cancel out hetero-polarization receive signals leaked into auto-polarization receive signals.

For example, the XPIC part 3 includes a transversal filter which generates a cross-polarization interference cancellation signal to cancel out cross-polarization interference components in auto-polarization receive signals, and a tap coefficient generation circuit which generates a tap coefficient enabling the cross-polarization interference cancellation signal to cancel out cross-polarization interference components in auto-polarization receive signals.

Additionally, the XPIC part 3 includes an adder which extracts a tap output signal for each tap in the traversal filter, adds the preset tap coefficient to the tap output signal, and then outputs the addition result as the cross-polarization interference cancellation signal.

Since the tap coefficient generation circuit adaptively controls the tap coefficient of the traversal filter, the XPIC part 3 generates the cross-polarization interference cancellation signal serving as reverse characteristics of cross-polarization interference components corresponding to hetero-polarization receive signal components included in auto-polarization receive signals.

The operator 4 subtracts a cross-polarization interference cancellation signal of the XPIC part 3 from an auto-polarization receive signal subjected to band limitation via the filter 2_1 so as to remove an allow-polarization receive signal component from the auto-polarization receive signal; thereafter, the auto-polarization receive signal is output to a signal processing circuit connected in the latter stage. The signal processing circuit carries out a decoding process.

Next, the operation of the cross-polarization interference cancellation device of the first embodiment will be described with reference to FIGS. 1 and 2. Similar to FIG. 1, FIG. 2 is a block diagram of a cross-polarization interference cancellation device installed in a receiver device. The configuration of FIG. 2 differs from the configuration of FIG. 1 in terms of the frequency of vertically-polarized waves.

FIG. 1 shows that the frequency band of horizontally-polarized waves includes the frequency band of vertically-polarized waves, and therefore the frequency band of horizontally-polarized waves is broader than the frequency band of vertically-polarized waves. In contrast, FIG. 2 shows that the frequency band of vertically-polarized waves includes the frequency band of horizontally-polarized waves, and therefore the frequency band of vertically-polarized waves is broader than the frequency band of horizontally-polarized waves.

First, a cross-polarization interference cancellation process will be described with respect to the case where the frequency band of horizontally-polarized waves is broader than the frequency band of vertically-polarized waves.

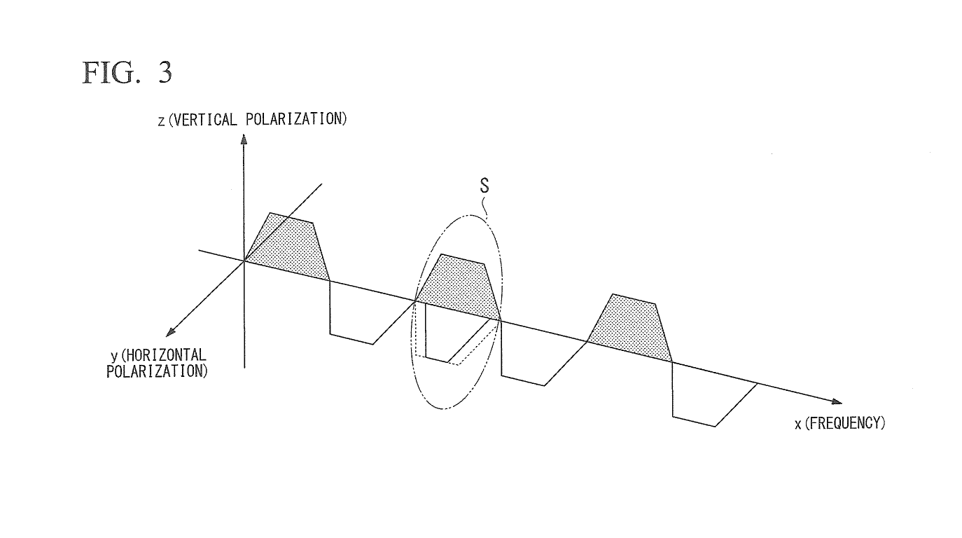

FIG. 3 is a conceptual drawing of a co-channel transmission system which transmits horizontally-polarized waves having a frequency bandwidth included in the frequency bandwidth of arbitrary vertically-polarized waves via interleaved allocations (i.e. an area S encompassed by dotted lines). In FIG. 3, an x-axis represents frequency; a y-axis represents horizontal polarization; and a z-axis represents vertical polarization. Hereinafter, a cross-polarization interference cancellation process which removes cross-polarization interference signal components serving as interference signals against vertically-polarized waves superimposed on horizontally-polarized waves will be described.

Referring back to FIG. 1, a graph g1 shows that a cross-polarization interference component (i.e. a vertically-polarized wave component), whose frequency bandwidth is narrower than the frequency bandwidth of a horizontally-polarized wave component, is superimposed on an auto-polarization receive signal corresponding to the frequency bandwidth of a horizontally-polarized wave. In the graph g1 (similar to graphs g2 to g7), the vertical axis represents signal intensity p while the horizontal axis represents frequency f. The graph g2 shows a vertically-polarized wave component corresponding to a hetero-polarization receive signal.

The gain adjuster 1_1 adjusts power of an auto-polarization receive signal (i.e. level adjustment) to maintain a constant level diagram in the latter-stage processing. Due to the level adjustment, the auto-polarization receive signal is changed from the signal intensity shown in the graph g1 to the signal intensity shown in the graph G3. At this time, the gain adjuster 1_1 operates to maintain constant power of the auto-polarization receive signal irrespective of its frequency bandwidth. For this reason, it is observed in view of frequency spectrum of an auto-polarization receive signal subjected to the level adjustment that, as shown in the graph g3, a modulation wave component including an interference wave (i.e. an auto-polarization receive signal component) has a constant area.

Similarly, the gain adjuster 1_2 adjusts power of a hetero-polarization receive signal (i.e. level adjustment) to maintain a constant level diagram in the latter-stage processing. Due to the level adjustment, a hetero-polarization receive signal is changed from the signal intensity shown in the graph g2 to the signal intensity shown in the graph g4. At this time the gain adjuster 12 operates to maintain constant power of a hetero-polarization receive signal irrespective of its frequency bandwidth. For this reason, it is observed in view of frequency spectrum of a hetero-polarization receive signal subjected to the level adjustment that, as shown in the graph g4, a modulation wave component (i.e. a hetero-polarization receive signal component) has a constant area.

Next, the filter 2_1 inputs the auto-polarization receive signal subjected to the power adjustment from the gain adjuster 1_1 so as to carry out a filtering process, which allows a signal component of a desired frequency band to solely pass therethrough, thus removing signal components of frequency bands other than the desired frequency band. Thus, it is possible to change the auto-polarization receive signal from the bandwidth shown in the graph g3 to the bandwidth shown in the graph g5.

The filter 2_2 inputs the hetero-polarization receive signal subjected to the power adjustment from the gain adjuster 1_2 so as to carry out a filtering process, which allows a signal component of a desired frequency band to solely pass therethrough, thus removing signal components of frequency bands other than the desired frequency band. Thus, it is possible to change the hetero-polarization receive signal from the bandwidth shown in the graph g4 to the bandwidth shown in the graph g6.

Thus, it is possible to complete a waveform shaping process with respect to the auto-polarization receive signal and the hetero-polarization receive signal.

As shown in FIG. 1 in which the frequency bandwidth of an auto-polarization receive signal is broader than the frequency bandwidth of a hetero-polarization receive signal serving as a cross-polarization interference cancellation signal, it is necessary that at least a hetero-polarization receive signal component exists in the frequency bandwidth of an auto-polarization receive signal in order to sufficiently cancel a cross-polarization interference component in the auto-polarization receive signal. For this reason, the first embodiment is designed such that the passing band of the filter 2_2 used to carry out a filtering process on a hetero-polarization receive signal is set identical to the passing band of the filter 2_1 used to carry out a filtering process on an auto-polarization receive signal.

The XPIC part 3 generates a cross-polarization interference cancellation signal shown in the graph g7 based on a hetero-polarization receive signal of the filter 2 2. The cross-polarization interference cancellation signal is highly correlative to the cross-polarization interference component included in the auto-polarization receive signal. The process of the XPIC part 3 generating a cross-polarization interference cancellation signal is embodied using the known technique using the foregoing transversal filter, the details of which are omitted here.

The operator 4 subtracts the cross-polarization interference cancellation signal of the XPIC part 3 from the auto-polarization receive signal of the filter 2_1 so as to cancel the cross-polarization interference component included in the auto-polarization receive signal. Thus, it is possible for the operator 4 to output the auto-polarization receive signal, precluding the cross-polarization interference component, to the next stage of circuitry.

As described above, it is necessary for the first embodiment to accurately retrieve the information of a cross-polarization interference component superimposed on an auto-polarization receive signal. For this reason, the frequency band of the filter 2_2 carrying out a filtering process on a hetero-polarization receive signal is set to the frequency band of the filter 2_1 carrying out a filtering process on an auto-polarization receive signal or more. Thus, it is possible to generate a cross-polarization interference cancellation signal eliminating a cross-polarization interference component superimposed on an auto-polarization receive signal.

According to the above configuration, it is possible to carry out a cross-polarization interference cancellation process when the frequency bandwidth of a horizontally-polarized wave is broader than the frequency bandwidth of a vertically-polarized wave, thus implementing a co-channel transmission system intended for the effective use of frequency bands used in radio communication by way of interleaved allocations of signal propagation frequencies with horizontally-polarized waves and vertically-polarized waves.

Next, a cross-polarization interference cancellation process will be described with respect to the case where the frequency bandwidth of a horizontally-polarized wave is narrower than the frequency bandwidth of a vertically-polarized wave as shown in FIG. 2.

As shown in a graph g11, a cross-polarization interference component (i.e. a vertically-polarized wave component) whose frequency bandwidth is broader than the frequency bandwidth of a horizontally-polarized wave overlaps with an auto-polarization receive signal in the frequency band of the horizontally-polarized wave. In the graph g11 (similar to graphs g12 to g17), the vertical axis represents signal intensity p while the horizontal axis represents frequency. The graph g12 shows a hetero-polarization receive signal in a vertically-polarized wave. The graph g12 shows that the frequency bandwidth of the hetero-polarization receive signal is broader than the frequency bandwidth of the auto-polarization receive signal.

The gain adjuster 1_1 adjusts power of the auto-polarization receive signal (i.e. level adjustment) to maintain a constant level diagram in the latter-stage processing. Due to the level adjustment, the auto-polarization receive signal is changed from the signal intensity shown in the graph g11 to the level intensity shown in the graph g13. At this time, the gain adjuster 1_1 operates to maintain constant power of the auto-polarization receive signal irrespective of frequency bandwidths. For this reason, it is observed in view of frequency spectrum of the auto-polarization receive signal subjected to the level adjustment that a modulation wave component including an interference wave (i.e. an auto-polarization receive signal component) has a constant area as shown in the graph g13.

Similarly, the gain adjuster 1_2 adjusts power of the hetero-polarization receive signal (i.e. level adjustment) to maintain a constant level diagram in the latter-stage processing. Due to the level adjustment, the hetero-polarization receive signal is changed from the signal intensity shown in the graph g12 to the level intensity shown in the graph g14. At this time, the gain adjuster 1_2 operates to maintain constant power of the hetero-polarization receive signal irrespective of frequency bandwidths. For this reason, it is observed in view of frequency spectrum of the hetero-polarization receive signal subjected to the level adjustment that a modulation wave component (i.e. a hetero-polarization receive signal component) has a constant area as shown in the graph g14. In the graph g14, dotted lines show the hetero-polarization receive signal component corresponding to the frequency bandwidth of the auto-polarization receive signal.

Next, the filter 2_1 inputs the auto-polarization receive signal subjected to the power adjustment from the gain adjuster 1_1 so as to carry out a filtering process to solely transmit a signal component of a desired frequency band therethrough, thus removing signal components of frequency bands other than the desired frequency band. Thus, the auto-polarization receive signal is changed from the bandwidth shown in the graph g13 to the bandwidth shown in the graph g15. As shown in the graph g15, it is possible to remove a certain amount of the cross-polarization interference component, which exists outside the frequency band of the auto-polarization receive signal, from the cross-polarization interference component superimposed on the auto-polarization receive signal.

The filter 2_2 inputs the hetero-polarization receive signal subjected to the power adjustment from the gain adjuster 1_2 so as to carry out a filtering process to solely transmit a signal component of a desired frequency band therethrough, thus removing signal components of frequency bands other than the desired frequency band. Thus, the hetero-polarization receive signal is changed from the bandwidth shown in the graph g14 to the bandwidth shown in the graph g16. As shown in the graph g16, it is possible to remove a hetero-polarization interference component, which exists outside the frequency band of the auto-polarization receive signal, from the hetero-polarization receive signal. That is, it is possible to solely extract the hetero-polarization receive signal component which exists in the frequency band of the auto-polarization receive signal. The frequency band of the extracted hetero-polarization receive signal component is identical to the frequency band of the cross-polarization interference component superimposed on the auto-polarization receive signal.

Thus, it is possible to complete a waveform shaping process with respect to the auto-polarization receive signal and the hetero-polarization receive signal.

As shown in FIG. 2 in which the frequency bandwidth of the auto-polarization receive signal is narrower than the frequency bandwidth of the hetero-polarization receive signal serving as the cross-polarization interference cancellation signal, it is necessary that at least the hetero-polarization receive signal component exists in the frequency bandwidth of the auto-polarization receive signal in order to adequately cancel the cross-polarization interference component in the auto-polarization receive signal. For this reason, the first embodiment is designed such that the passing band of the filter 22, which is used to carry out a filtering process on the hetero-polarization receive signal, is set identical to the passing band of the filter 2_1, which is used to carry out a filtering process on the auto-polarization receive signal.

The XPIC part 3 generates a cross-polarization interference cancellation signal shown in the graph g17 based on the hetero-polarization receive signal of the filter 2_2. The cross-polarization interference cancellation signal is highly correlative to the cross-polarization interference component included in the auto-polarization receive signal.

The operator 4 subtracts the cross-polarization interference cancellation signal of the XPIC part 3 from the auto-polarization receive signal of the filter 2_1, thus cancelling the cross-polarization interference component included in the auto-polarization receive signal. Thus, the operator 4 outputs the auto-polarization receive signal, precluding the cross-polarization interference component, to the next stage of circuitry.

As described above, it is necessary for the first embodiment to accurately retrieve the information of the cross-polarization interference component superimposed on the auto-polarization receive signal. For this reason, the frequency band of the filter 2_2, which carries out a filtering process on the hetero-polarization receive signal, is set identical to the frequency band of the filter 2_1, which carries out a filtering process on the auto-polarization receive signal, or more. Thus, it is possible to generate the cross-polarization interference cancellation signal eliminating the cross-polarization interference component superimposed on the auto-polarization receive signal.

According to the above configuration, it is possible to implement a cross-polarization interference cancellation process with respect to the case where the frequency bandwidth of a horizontally-polarized wave is narrower than the frequency bandwidth of a vertically-polarized wave in addition to the case where the frequency bandwidth of a horizontally-polarized wave is broader than the frequency bandwidth of a vertically-polarized wave. Thus, it is possible to realize a co-channel transmission system intended for the effective use of frequency bands in radio communication via interleaved allocations of signal propagation frequencies with horizontally-polarized waves and vertically-polarized waves.

As described above, the first embodiment may employ the filter 2_2 whose passing band includes the frequency band of the auto-polarization receive signal and whose passing band is broader than the frequency band of the auto-polarization receive signal. Alternatively, the first embodiment may set the same passing band to the filter 2_1 of the auto-polarization receive signal and the filter 2_2 of the hetero-polarization receive signal. Thus, it is possible to implement a cross-polarization interference cancellation process even when the frequency bandwidth of the auto-polarization receive signal differs from that of the hetero-polarization receive signal cross-interfered with the auto-polarization receive signal. Thus, it is possible for the first embodiment to realize a co-channel transmission system intended for the effective use of frequency band in radio communication via interleaved allocations of signal propagation frequencies with horizontally-polarized waves and vertically-polarized waves.

### Second Embodiment

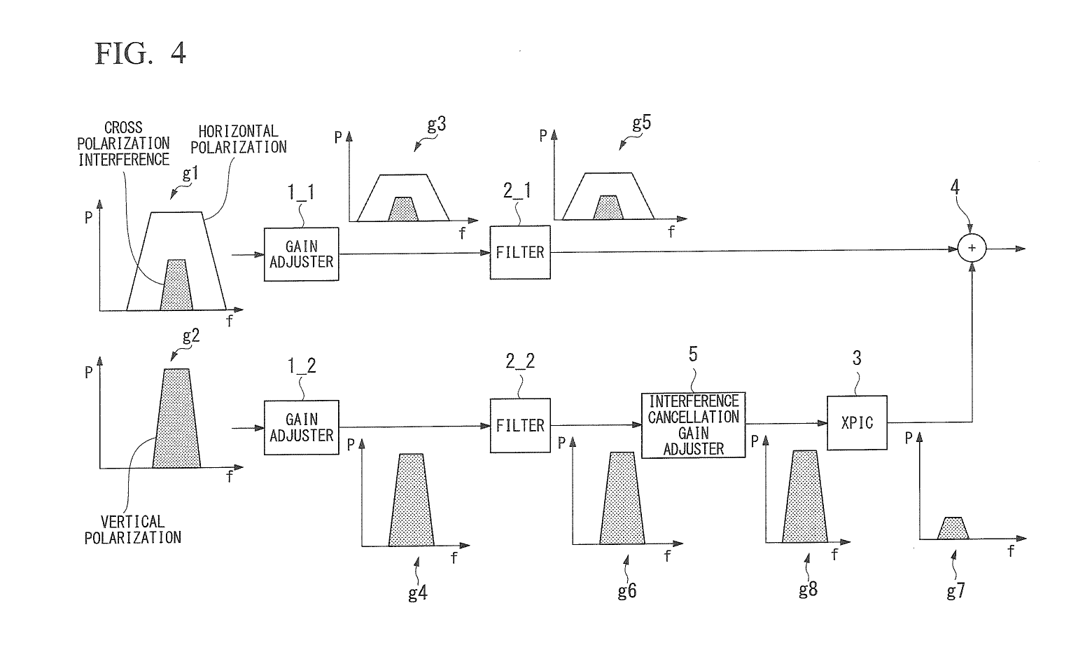

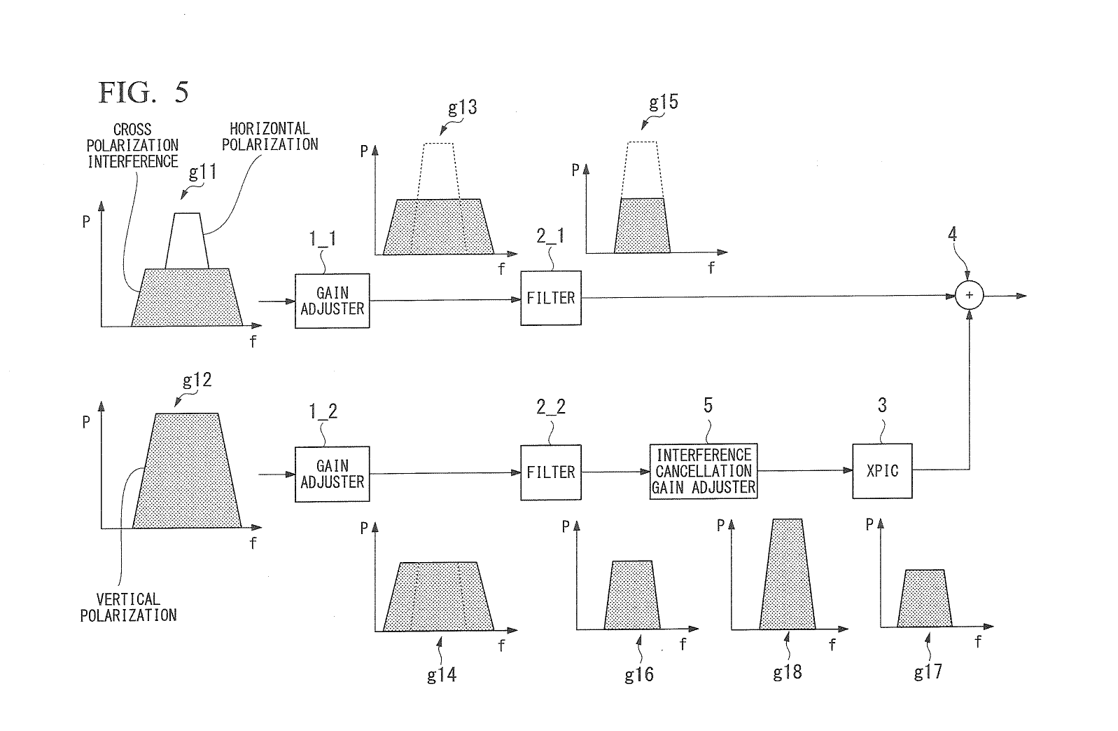

Next, the second embodiment of the present invention will be described in detail with reference to FIGS. 4 to 8. FIGS. 4 and 5 are block diagrams each showing the configuration of a cross polarization interference cancellation device according to the second embodiment of the present invention. Similar to the first embodiment, the second embodiment is designed such that horizontally-polarized waves are used as auto-polarization waves while vertically-polarized waves are used as hetero-polarization waves; but this is not a restriction. That is, it is possible to reconfigure the second embodiment such that vertically-polarized waves are used as auto-polarization waves while horizontally-polarized waves are used as hetero-polarization waves.

As shown in FIGS. 4 and 5, the cross polarization interference cancellation device of the second embodiment includes the gain adjusters 1_1, 1_2, the filters 2_1, 2_2, the XPIC part 3, the operator 4, and an interference cancellation gain adjuster 5.

Since the first embodiment and the second embodiment overlap with each other in terms of their configurations, a different constituent element between them will be solely described below. The cross polarization interference cancellation device of the second embodiment differs from the cross polarization interference cancellation device of the first embodiment by way of the interference cancellation gain adjuster 5. The interference cancellation gain adjuster 5 increases the signal intensity of a hetero-polarization receive signal subjected to a filtering process in the filter 2_2 (i.e. gain adjustment).

Next, the reason why the interference cancellation gain adjuster 5 is arranged in the cross polarization interference cancellation device will be described. The traversal filter of the XPIC part 3 carries out a process to correlate an error component of an auto-polarization receive signal (i.e. a cross-polarization interference component) and a cross-polarization interference cancellation signal by use of the number of taps and tap coefficients. Herein, it is necessary to adjust tap coefficients in a range from zero to a maximum settable value since the number of taps is constant.

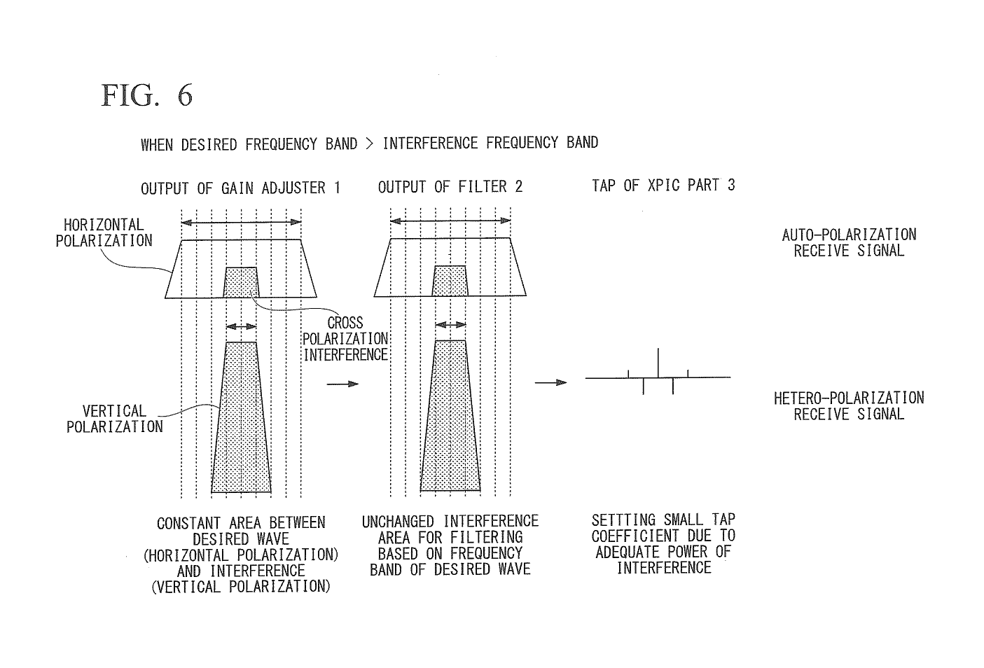

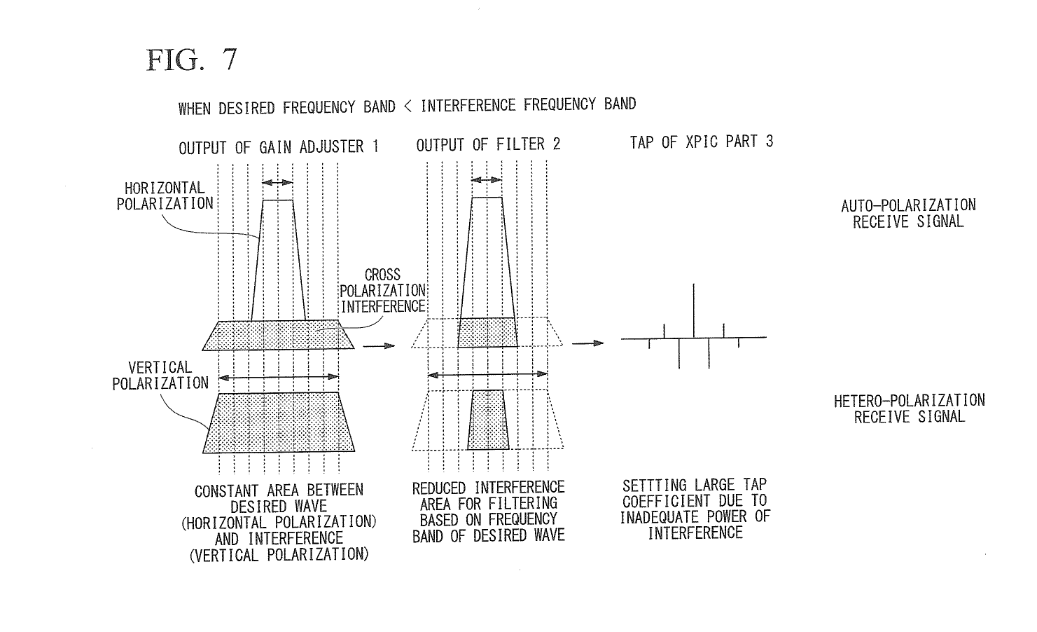

FIGS. 6 and 7 conceptually show the method of setting tap coefficients which are used to generate a cross-polarization interference cancellation signal based on a hetero-polarization receive signal of the filter 2_2. FIG. 6 shows tap coefficients when the frequency bandwidth of an auto-polarization receive signal is broader than the frequency bandwidth of a hetero-polarization receive signal. FIG. 7 shows tap coefficients when the frequency bandwidth of an auto-polarization receive signal is narrower than the frequency bandwidth of a hetero-polarization receive signal

In the case of FIG. 6, the same area of power on graphs is applied to an auto-polarization receive signal and a hetero-polarization receive signal by way of the gain adjusters 1_1 and 1_2, wherein the frequency band of the hetero-polarization receive signal is included in the frequency band of the auto-polarization receive signal. In the filter 2_2 transmitting a hetero-polarization receive signal therethrough, the signal component of the hetero-polarization receive signal is directly transmitted through the filter 2_2 without being removed. That is, the power of the hetero-polarization receive signal is not changed before and after the filter 2_2. Since an adequate power is maintained in a hetero-polarization receive signal, the XPIC part 3 may need a small tap coefficient to generate a cross-polarization interference cancellation signal based on the hetero-polarization receive signal of the filter 2_2.

In the case of FIG. 7 in which the same area of power on graphs is applied to an auto-polarization receive signal and a hetero-polarization receive signal by way of the gain adjusters 1_1 and 1_2, and therefore the frequency band of the hetero-polarization receive signal is not included in the frequency band of the auto-polarization receive signal. A hetero-polarization receive signal component, which exists outside a desired frequency band (i.e. the frequency band of an auto-polarization receive signal), is removed when a hetero-polarization receive signal is transmitted through the filter 2_2. The power of the hetero-polarization receive signal transmitted through the filter 2_2 is decreased in response to the ratio between the frequency bandwidth of the hetero-polarization receive signal and the frequency bandwidth of the auto-polarization receive signal. Due to an inadequate power of the hetero-polarization receive signal, it is necessary for the XPIC part 3 to increase a tap coefficient to generate a cross-polarization interference cancellation signal based on the hetero-polarization receive signal of the filter 2_2.

In the case of FIG. 7 in which the frequency band of a hetero-polarization receive signal is broader than the frequency band of an auto-polarization receive signal, the hetero-polarization receive signal is decreased in power when being transmitted through the filter 2_2, and therefore the power of the hetero-polarization receive signal greatly differs from the power of the auto-polarization receive signal. In other words, the power of the hetero-polarization receive signal becomes smaller than the power of the auto-polarization receive signal since the hetero-polarization receive signal passes through the filter 2_2 even though the same power (i.e. the same area on graphs) is applied to the auto-polarization receive signal and the hetero-polarization receive signal by way of the gain adjusters 1_1 and 1_2. To cancel a power difference between the auto-polarization receive signal and the hetero-polarization receive signal, it is necessary to increase tap coefficients of the XPIC part 3 so that the power of the hetero-polarization receive signal will match with the power of a cross-polarization interference component included in the auto-polarization receive signal.

In the above case, it is necessary to secure a large number of bits with respect to the output signal of the XPIC part 3 (i.e. the result of multiplying the hetero-polarization receive signal by a tap coefficient). Due to a restriction to the circuit scale, however, it is impossible to secure an adequate number of bits with respect to the output signal of the XPIC part 3, and therefore it is impossible to generate a cross-polarization interference cancellation signal, which is able to eliminate a cross-polarization interference component superimposed on the auto-polarization receive signal, when a significant interference occurs between auto-polarized waves and hetero-polarized waves. Despite a significant interference occurring between auto-polarized waves and hetero-polarized waves, it is necessary to generate a cross-polarization interference signal, which is able to eliminate a cross-polarization interference component superimposed on the auto-polarization receive signal, without increasing the number of bits with respect to the output signal of the XPIC part 3 multiplying the hetero-polarization receive signal by a tap coefficient. For this reason, the interference cancellation gain adjuster 5 is introduced into the cross polarization interference cancellation device of the second embodiment.

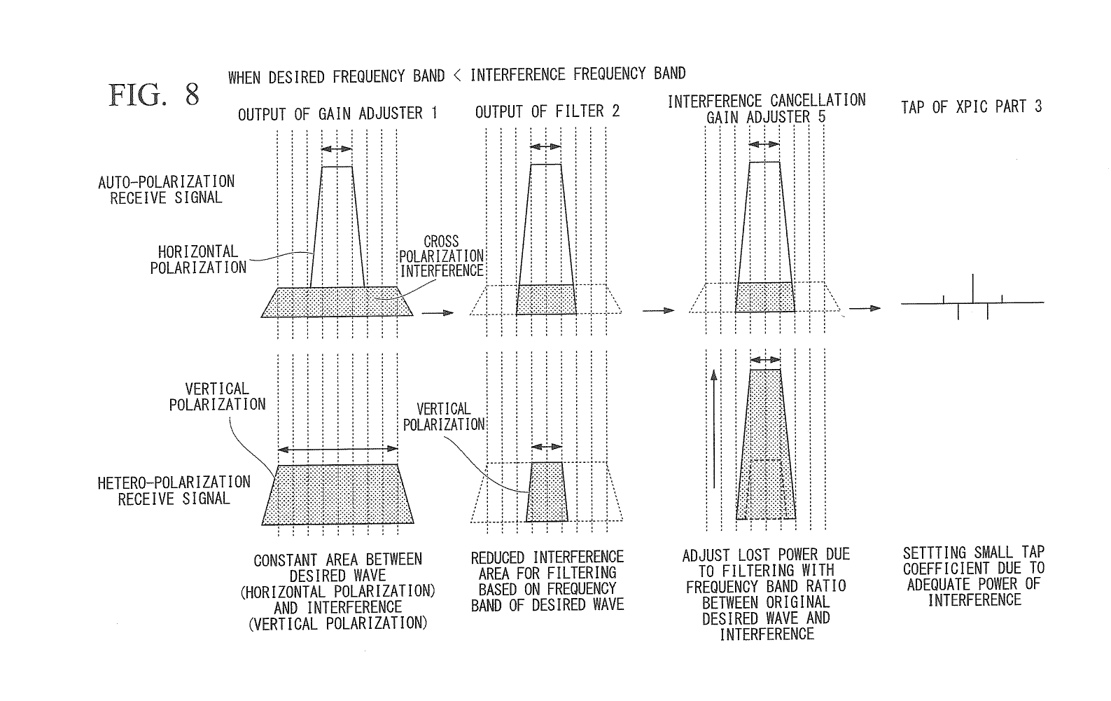

FIG. 8 conceptually shows a method of setting tap coefficients which are used to generate a cross-polarization interference cancellation signal based on a hetero-polarization receive signal which is subjected to a filtering process in the filter 2_2 and then amplified by the interference cancellation gain adjuster 5. FIG. 8 show the case where the frequency bandwidth of a hetero-polarization receive signal is broader than the frequency bandwidth of an auto-polarization receive signal. As described above, when the frequency bandwidth of a hetero-polarization receive signal is narrower than the frequency bandwidth of an auto-polarization receive signal, a hetero-polarization receive signal component has an adequate power to generate a cross-polarization interference cancellation signal without increasing the number of bits for the output signal of the XPIC part 3; hence, descriptions thereof will be omitted here.

When the same area on graphs is applied to an auto-polarization receive signal and a hetero-polarization receive signal by way of the gain adjusters 1_1 and 12, the frequency band of the hetero-polarization receive signal is not included in the frequency band of the auto-polarization receive signal, and therefore it is possible to remove a hetero-polarization receive signal component, which exists outside a desired frequency band (i.e. the frequency band of the auto-polarization receive signal), when the hetero-polarization receive signal is transmitted through the filter 2_2. For this reason, the power of the hetero-polarization receive signal after passing through the filter 2_2 is decreased in response to the ratio between the frequency bandwidth of the hetero-polarization receive signal and the frequency bandwidth of the auto-polarization receive signal.

In the second embodiment in which the interference cancellation gain adjuster 5 amplifies the hetero-polarization receive signal after passing through the filter 22, it is possible to compensate for the power equivalent to the hetero-polarization receive signal component which is removed by the filter 2_2. That is, it is unnecessary to increase the number of bits for the output signal of the XPIC part 3 generating a cross-polarization interference cancellation signal based on a hetero-polarization receive signal since the XPIC part 3 is supplied with the hetero-polarization receive signal having adequate power.

FIG. 4 shows a process of generating a cross-polarization interference cancellation signal when the frequency band of an auto-polarization receive signal is broader than the frequency band of a hetero-polarization receive signal. Thus, the processing of an auto-polarization receive signal shown in the graphs g1 to g5 and the processing of a hetero-polarization receive signal shown in the graphs g2 to g6 in FIG. 4 are identical to those of the first embodiment shown in FIG. 1.

In FIG. 4, the interference cancellation gain adjuster 5 inputs the hetero-polarization receive signal from the filter 2_2 so as to amplifies the power shown in the graph g6 with the power shown in a graph g8. The hetero-polarization receive signal amplified by the interference cancellation gain adjuster 5 is subsequently supplied to the XPIC part 3. As a result, the XPIC part 8 generates a cross-polarization interference cancellation signal shown in the graph g7 based on the hetero-polarization receive signal shown in the graph g8.

FIG. 5 shows a process of generating a cross-polarization interference cancellation signal when the frequency band of an auto-polarization receive signal is narrower than the frequency band of a hetero-polarization receive signal. In FIG. 5, the processing of an auto-polarization receive signal shown in the graphs g11 to g15 and the processing of a hetero-polarization receive signal shown in the graphs 12 to g16 in FIG. 5 are identical to those of the first embodiment shown in FIG. 1. In FIG. 5, the interference cancellation gain adjuster 5 inputs the hetero-polarization receive signal from the filter 2_2 so as to amplify the power shown in the graph g16 with the power shown in a graph g18.

The hetero-polarization receive signal amplified by the interference cancellation gain adjuster 5 is subsequently supplied to the XPIC part 3. As a result, the XPIC part 3 generates a cross-polarization interference cancellation signal based on the hetero-polarization receive signal amplified by the interference cancellation gain adjuster 5.

In addition to the foregoing effect of the first embodiment which is able to implement a co-channel transmission system intended for the effective use of frequency bands via interleaved allocations of signal propagation frequencies with horizontally-polarized waves and vertically-polarized waves, the second embodiment is able to demonstrate an effect of generating a cross-polarization interference cancellation signal, which is used to eliminate a cross-polarization interference component superimposed on an auto-polarization receive signal, without increasing the number of bits for the output signal of the XPIC part 3 irrespective of a significant interference occurring between cross-polarized waves when the frequency bandwidth of a hetero-polarized receive signal is broader than the frequency bandwidth of an auto-polarization receive signal.

### Third Embodiment

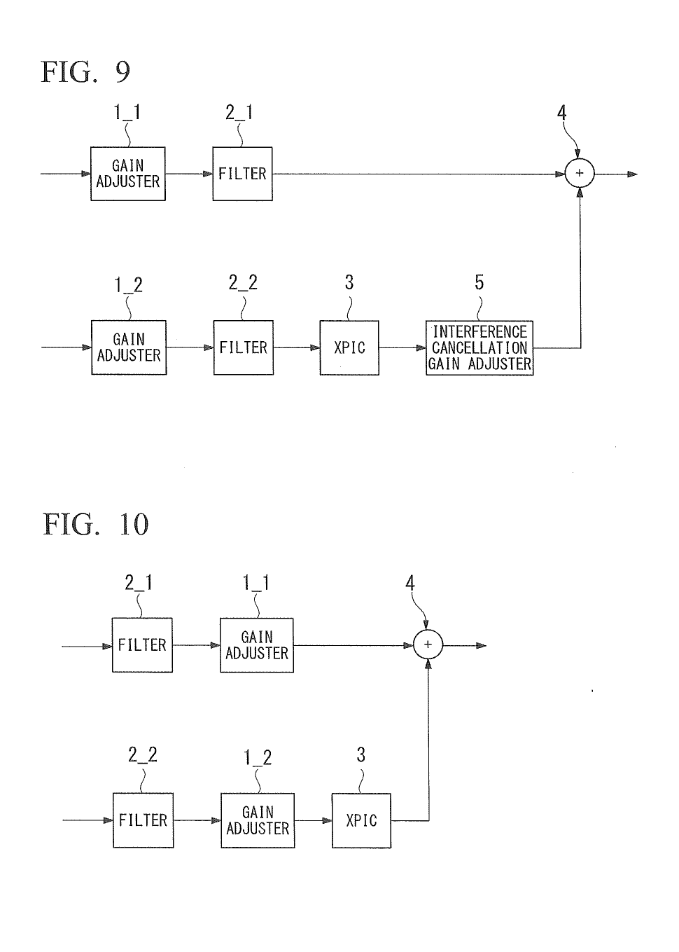

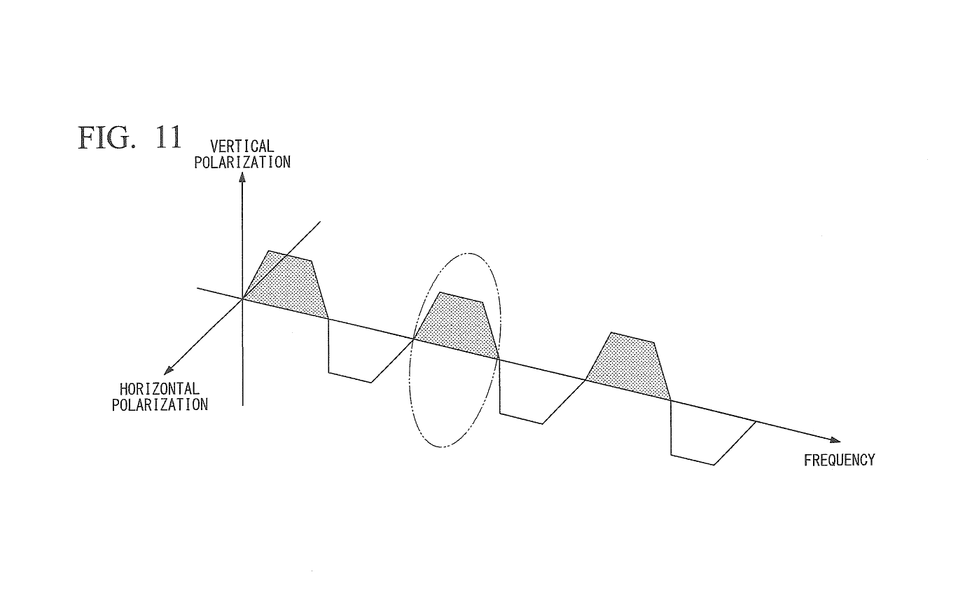

Next, the third embodiment of the present invention will be described with reference to FIG. 9. FIG. 9 is a block diagram showing the configuration of a cross polarization interference cancellation device according to the third embodiment. The cross polarization interference cancellation device of the third embodiment includes the same constituent elements as the cross polarization interference cancellation device of the second embodiment (FIGS. 5 and 6). Compared with the second embodiment, the third embodiment employs the reversed order of the XPIC part 3 and the interference cancellation gain adjuster 5 connected together. In the third embodiment having this configuration, the interference cancellation gain adjuster 5 amplifies the power of a cross-polarization interference cancellation signal which is generated by the XPIC part 3 based on a hetero-polarization receive signal transmitted through the filter 2_2. Similar to the second embodiment, it is possible for the third embodiment to adequately compensate for an auto-polarization receive signal while eliminating a cross-polarization interference component superimposed on the auto-polarization receive signal.

### Fourth Embodiment

Next, the fourth embodiment of the present invention will be described with reference to FIG. 10. FIG. 10 is a block diagram showing the configuration of a cross polarization interference cancellation device according to the fourth embodiment. The cross polarization interference cancellation device of the fourth embodiment has the same constituent elements as the cross polarization interference cancellation device of the first embodiment (FIGS. 1 and 2). Compared to the first embodiment, the fourth embodiment employs the reverse order of the gain adjuster 1_1 and the filter 2_1 connected together and the reverse order of the gain adjuster 1_2 and the filter 2_2 connected together. In the fourth embodiment having this configuration, it is possible to compensate for a power reduction which occurs when an auto-polarization receive signal and a hetero-polarization receive signal pass through the filters because the same frequency band is applied to both the auto-polarization receive signal and the hetero-polarization receive signal and then the same power is applied to them by way of gain adjustment, and therefore it is unnecessary to arrange the interference cancellation gain adjuster 5 employed in the third embodiment. Similar to the foregoing embodiments, it is possible for the fourth embodiment to adequately compensate for an auto-polarization receive signal while eliminating a cross-polarization interference component superimposed on the auto-polarization receive signal.

It is possible to store programs, implementing the functions of the cross polarization interference cancellation devices according to the foregoing embodiments (FIGS. 1, 2, 4, 5, 9, and 10), in computer-readable storage media. It is possible to carry out the foregoing cross polarization interference cancellation processes in accordance with programs which are read from storage media and executed by computer systems. Herein, the “computer system” may embrace software such as OS (Operating System) and hardware such as peripheral devices. The “computer system” utilizing the WWW system may embrace homepage providing environments (or homepage displaying environments).

The “computer-readable storage media” may embrace flexible disks, magneto-optical sensor disks, ROM, portable storage media such as CD-ROM, or storage media such as hard disks installed in computer systems. Additionally, the “computer-readable storage media” may embrace transmission media dynamically retaining programs for a short period of time, e.g. networks such as the Internet and communication lines such as telephone lines which are used to transmit programs. Moreover, the “computer-readable storage media” may embrace storage media retaining programs for a certain period of time, e.g. nonvolatile memories installed in computer systems serving as servers and clients which are used to transmit programs via transmission media. The foregoing programs may implement a part of cross polarization interference cancellation processes according to the present invention. Alternatively, the foregoing programs may be combined with programs pre-installed in computer systems so as to achieve cross polarization interference cancellation processes.

The present invention is described by way of cross polarization interference cancellation devices and methods with reference to the accompanying drawings. Details of configurations and processes are not necessarily limited to the foregoing embodiments; hence, the present invention may embrace a variety of modifications and design changes within the scope of the invention as defined in the appended claims.

### INDUSTRIAL APPLICABILITY

The present invention is designed to carry out a cross polarization interference cancellation process in a co-channel transmission system via interleaved allocations of radio signals with horizontally-polarized and vertically-polarized waves having the same frequency, and therefore the present invention is applicable to information processing devices equipped with a variety of radio devices or radio functions.

### REFERENCE SIGNS LIST

1_1, 1_2 gain adjuster
2_1, 2_2 filter
3 XPIC part
4 operator
5 interference cancellation gain adjuster

1. A cross polarization interference cancellation device adapted to a radio communication device in a co-channel transmission system using auto-polarization waves and hetero-polarization waves with phases orthogonally crossing each other at a same frequency, the cross polarization interference cancellation device comprising:
a first filter which is configured to eliminate components other than a predetermined frequency band from an auto-polarization signal;
a second filter which is configured to eliminate components other than the predetermined frequency band from a hetero-polarization signal;
a cross polarization interference cancellation part which is connected to the second filter so as to generate a cross-polarization interference cancellation signal which is used to eliminate the hetero-polarization signal serving as a cross-polarization interference component superimposed on the auto-polarization signal; and
an operator which is configured to subtract the cross-polarization interference cancellation signal from the auto-polarization signal passing through the first filter, thus compensating for the auto-polarization signal,
wherein a frequency band of the first filter is included in a frequency band of the second filter.

2. The cross polarization interference cancellation device according to claim 1, wherein the frequency band of the first filter is identical to the frequency band of the second filter.

3. The cross polarization interference cancellation device according to claim 1, further comprising a first gain adjuster which is configured to amplify the auto-polarization signal and a second gain adjuster which is configured to amplify the hetero-polarization signal.

4. The cross polarization interference cancellation device according to claim 1, further comprising an interference cancellation gain adjuster which is connected to the second filter so as to amplify the hetero-polarizaiton signal passing through the second filter.

5. The cross polarization interference cancellation device according to claim 1, further comprising an interference cancellation gain adjuster which is connected to the cross polarization interference cancellation part so as to amplify the cross polarization interference cancellation signal.

6. The cross polarization interference cancellation device according to claim 1, further comprising a first gain adjuster which is connected to the first filter so as to amplify the auto-polarization signal passing through the first filter and a second gain adjuster which is connected to the second filter so as to amplify the hetero-polarization signal passing through the second filter.

7. A cross polarization interference cancellation method adapted to radio communication in a co-channel transmission system using auto-polarization waves and hetero-polarization waves with phases orthogonally crossing each other at a same frequency, the cross polarization interference cancellation method comprising:
a first filtering process of eliminating components other than a predetermined frequency band from an auto-polarization signal;
a second filtering process of eliminating components other than the predetermined frequency band from a hetero-polarization signal;
a cross polarization interference cancellation process of generating a cross-polarization interference cancellation signal which is used to eliminate the hetero-polarization signal serving as a cross-polarization interference component superimposed on the auto-polarization signal based on the hetero-polarization signal after the second filtering process; and
an operation process of subtracting the cross-polarization interference cancellation signal from the auto-polarization signal passing through the first filtering process, thus compensating for the auto-polarization signal,
wherein a frequency band of the first filtering process is included in a frequency band of the second filtering process.

8. The cross polarization interference cancellation device according to claim 3, further comprising an interference cancellation gain adjuster which is connected to the second filter so as to amplify the hetero-polarizaiton signal passing through the second filter.

9. The cross polarization interference cancellation device according to claim 3, further comprising an interference cancellation gain adjuster which is connected to the cross polarization interference cancellation part so as to amplify the cross polarization interference cancellation signal.
